(19) United States
(12) Patent Application Publication
(10) Pub. No.: US 2025/0289267 A1
(43) Pub. Date: Sep. 18, 2025

(54) FOLDABLE WHEEL AND ROBOT

(71) Applicant: Beihang University, Beijing (CN)

(72) Inventors: Sha YIN, Beijing (CN); Chao MA, Beijing (CN); Yuan TIAN, Beijing (CN); Zhuo CHEN, Beijing (CN)

(73) Assignee: Beihang University, Beijing (CN)

(21) Appl. No.: 19/071,955

(22) Filed: Mar. 6, 2025

(30) Foreign Application Priority Data
Mar. 12, 2024 (CN) 202410276943.0

(51) Int. Cl. B60B 19/04; B25J 5/00

(52) U.S. Cl. CPC B60B 19/04; B25J 5/007

(57) ABSTRACT

A foldable wheel and a robot, where the foldable wheel includes a hub, a plurality of foldable unit cells, a plurality of spoke plates, a collar, an elastic connecting member and a driving structure. Where the foldable unit cell is connected with the spoke plate, and the spoke plate is between two adjacent unit cells, the spoke plate is connected with an outer peripheral surface of the hub, two ends of the hub are rotationally connected with the collar, and the elastic connecting member connects the collar and the spoke plate. The driving system drives the collar to rotate relative to the hub and pulls the spoke plate through the elastic connecting member to realize the folding and unfolding of the unit cell, so that the wheel is changeable in diameter.

### CROSS-REFERENCE TO RELATED APPLICATIONS

This application claims priority to Chinese Patent Application No. 202410276943.0, filed on Mar. 12, 2024, which is hereby incorporated by reference in its entirety.

### TECHNICAL FIELD

Embodiments of the present application relate to the technical field of diameter variable wheels, and in particular to a foldable wheel and a robot.

### BACKGROUND

With the rapid development of robots, they are widely used in wilderness exploration, household sweeping and other fields. Robots need to overcome various types of obstacles when moving in different environments. Especially in small space or under a rugged road condition, the mobility of the robots is particularly important. In the moving modes of robots, the legged type has complex structure and

control mode, the tracked type has insufficient moving speed and flexibility, while the wheeled type can achieve the fastest moving speed and the simplest control mode. So the mobile robots often uses wheeled type of moving mode. However, the traditional wheel has fixed shape and size, and it cannot adapt to different road conditions when facing complex scenarios. For example, when crossing obstacles in low gaps, a small wheel diameter is needed to lower the overall center of gravity; and when facing rugged roads or soft roads, a larger wheel diameter is needed to improve the climbing ability and passing performance of the robot.

In order to balance the mobile robot's moving speed and its ability to adapt to different road conditions, and considering the practicality, simple and reliable structure and control mode are required. We propose a foldable wheel and robot.

### SUMMARY

The embodiment of the present application provides a foldable wheel and a robot, which realizes a change in diameter of the wheel through folding and unfolding of foldable unit cells, so as to improve the obstacle crossing ability of the robot under complex road conditions. They are simple in process, easy to install, and use a lightweight material for reducing the weight of the wheel and reducing energy consumption during operation of the robot.

Embodiments of the present application provide the following technical solutions for solving the above-mentioned technical problems.

An embodiment of the present application provides a foldable wheel, including:
a hub with an outer peripheral surface;
a plurality of foldable unit cells, where each unit cell has a first end and a second end, the plurality of unit cells are arranged in a circle along the outer peripheral surface of the hub, and each unit cell includes a flexible support layer and a plurality of elastic cover plates distributed on at least one surface of the flexible support layer;
a plurality of spoke plates with elasticity, where each spoke plate is positioned between two adjacent unit cells, one end of each spoke plate is connected to the outer peripheral surface of the hub and connected to first ends of the two adjacent unit cells, and the other end of each spoke plate is connected to second ends of the two adjacent unit cells;
a collar, arranged at each of both ends of the hub, the collar being rotatably connected with the hub;
an elastic connecting member, one end of which is connected to the spoke plates and the other end of which is connected to the collar; and
a driving structure, driving the collar to rotate so that the elastic connecting member drives the unit cell to fold or unfold.

Beneficial effects of the embodiment of the present application: the foldable wheel provided by the embodiment of the present application includes a hub, a plurality of foldable unit cells, a plurality of spoke plates, a collar, an elastic connecting member, and a driving structure, where the hub has an outer peripheral surface, each unit cell has a first end and a second end, the plurality of unit cells are arranged in a circle along the outer peripheral surface of the hub, each unit cell includes a flexible support layer and a plurality of elastic cover plates, the elastic cover plates are distributed on at least one surface of the flexible support layer; the spoke plates are elastic, each spoke plate is positioned between two adjacent unit cells, one end of each spoke plate is connected to an outer peripheral surface of the hub and connected to a first end of the two adjacent unit cells, and the other end of each spoke plate is connected to a second end of the two adjacent unit cells; both ends of the hub are provided with a collar, and the collar is rotatably connected with the hub, and the spoke plates are connected with the collar by the elastic connecting member; and the driving structure drives the collar to rotate so that the elastic connecting member drives the unit cells to fold or unfold. That is, the foldable unit cell is connected to the spoke plate, the spoke plate is between two adjacent unit cells, the spoke plate is connected with the outer peripheral surface of the hub, two ends of the hub are rotationally connected with the collar, and the elastic connecting member is connected with the collar and the spoke plate. Driving the collar to rotate relative to the hub by the driving system and pulling the spoke plate by the elastic connecting member realize the folding and unfolding of the unit cell, so that the wheel is changeable in diameter, and the robot has an improved obstacle crossing ability under complex road conditions, with a simple process and a convenient installation.

In a possible embodiment, the flexible support layer includes two opposite folding layers and two connecting layers;
at least one surface of each folding layer is provided with the elastic cover plate;
the two folding layers are connected with the two connecting layers, and ends of the two connecting layers towards the hub are connected, the two folding layers and the two connecting layers enclose a cavity with an opening at one end, and the opening of the cavity faces away from the hub; and
the connecting layer is connected with both ends of the spoke plate.

In a possible embodiment, the folding layer has a first region and a second region, and at least one surface of each of the first region and the second region is provided with the elastic cover plate;
when the unit cell is in a folded state, the folding layer is folded toward the cavity, and the first region and the second region are at least partially overlapped; and
when the unit cell is in an unfolded state, the folding layer is unfolded, and the first region and the second region are in a same plane.

In a possible embodiment, the first region and the second region gradually increase in a direction from the first end to the second end of the unit cell.

In a possible embodiment, two protrusions are provided on one end of the spoke plate facing away from the hub, and one end of the elastic connecting member is connected to the spoke plate by the protrusion.

In a possible embodiment, the hub is internally provided with a partition plate, the partition plate is provided with a first connecting hole and a second connecting hole, and the first connecting hole is located at a central position of the partition plate.

In a possible embodiment, the driving structure includes a motor, both ends of the motor are each provided with a connecting shaft, and the other end of each connecting shaft is provided with a gear head;
when the motor runs and drives the gear head to rotate in a first direction, the unit cell is in a folded state; and when the motor runs and drives the gear head to rotate in a second direction, the unit cell is in an unfolded state;
the second direction is opposite to the first direction; and
an internal gear is arranged in the collar, and the internal gear is meshed with the gear head of the motor.

In a possible embodiment, the motor is provided in the second connecting hole of the partition plate; and
the motor is also provided with at least one connecting portion, and the motor is connected with the partition plate of the hub through the connecting portion.

In a possible embodiment, a plurality of pull ring is provided outside the collar, and the other end of the elastic connecting member is connected to the collar by the pull ring.

An embodiment of the present application further provides a robot, including:
an actuator structure, a wheel axle, and the foldable wheel according to any one of the above embodiments, where the actuator structure is located at an upper end of the wheel axle, both ends of the wheel axle are each connected to a first connecting hole of the hub of the foldable wheel;
the robot has a first state and a second state, and when the robot is in the first state, the unit cell is in a folded state, and the robot is used to cross a low gap; and
when the robot is in the second state, the unit cell is in an unfolded state, and the robot is used to quickly move or cross a road obstacle.

In addition to the technical problems solved by the present application, the technical features constituting the technical solutions, and the beneficial effects brought by the technical features of the technical solutions described above, other technical problems that can be solved by the foldable wheel and the robot provided by the present application, other technical features included in the technical solutions and the beneficial effects brought by the technical features will be described in detail in the specific embodiments.

### BRIEF DESCRIPTION OF DRAWINGS

To describe the technical solutions in embodiments of the present application or in the prior art more clearly, the following briefly introduces the accompanying drawings needed for describing the embodiments of the present application or the prior art. Apparently, the accompanying drawings in the following description illustrate merely some embodiments of the present application, and these drawings and descriptions are not intended to limit the scope of the concept of the present application in any way, but to explain the concept of the present application to those skilled in the art by referring to specific embodiments. For a person of ordinary skill in the art, other drawings can be obtained from these drawings without creative efforts.

FIG. 1 is a schematic structural diagram of a foldable wheel in an unfolded state according to an embodiment of the present application.

FIG. 2 is a schematic structural diagram of a unit cell of a foldable wheel according to an embodiment of the present application.

FIG. 3 is a schematic structural diagram of an unfolded unit cell of a foldable wheel according to an embodiment of the present application.

FIG. 4 is a schematic structural diagram of a spoke plate of a foldable wheel according to an embodiment of the present application.

FIG. 5 is a schematic structural diagram of a hub of a foldable wheel according to an embodiment of the present application.

FIG. 6 is a schematic structural diagram of a collar of a foldable wheel according to an embodiment of the present application.

FIG. 7 is a schematic structural diagram of a driving system of a foldable wheel according to an embodiment of the present application.

FIG. 8 is a schematic structural diagram of a folded unit cell of a foldable wheel according to an embodiment of the present application.

FIG. 9 is a schematic structural diagram of a foldable wheel in a folded state according to an embodiment of the present application.

FIG. 10 is a schematic structural diagram of a robot according to an embodiment of the present application.

### Description of Reference Numbers

10—actuator structure; 20—wheel axle; 30—wheel;
100—hub; 200—unit cell; 300—spoke plate; 400—collar; 500—elastic connecting member; 600—driving structure;
110—outer peripheral surface; 120—partition plate; 130—first connecting hole; 140—second connecting hole; 150—third connecting hole; 160—fourth connecting hole;
210—first end; 220—second end; 230—cavity; 240—flexible support layer; 250—elastic cover plate; 260—rivet hole; 270—first opening;
241—folding layer; 242—connecting layer;
2411—first region; 2412—second region; 2413—crease;
310—protrusion; 320—fifth connecting hole; 330—second opening;
311—sixth connecting hole;
410—internal gear; 420—pull ring;
610—motor; 620—connecting portion; 630—connecting shaft; 640—gear head.

### DESCRIPTION OF EMBODIMENTS

With the rapid development of robots, challenges are posed to the movement of robots in different environments. For example, in a small space, robots need to have a small size and flexible posture adjustment ability in order to smoothly pass narrow passages. In rugged road conditions, robots need to have strong climbing ability and stability to cope with uneven roads and obstacles.

In view of this, the embodiments of the present application provide a hub, a plurality of foldable unit cells, a plurality of spoke plates, a collar, an elastic connecting member, and a driving structure. The foldable unit cell is connected with the spoke plate, and the spoke plate is between two adjacent unit cells. The spoke plate is connected with the outer peripheral surface of the hub, two ends of the hub are rotatablely connected with the collar, and the elastic connecting member is connected with the collar and the spoke plate. Through the fact that the driving system drives the collar to rotate relative to the hub, and the elastic connecting member pulls the spoke plate, the folding of the unit cell is realized, so that the wheel is changeable in diameter and has a highly deformable capacity and self-adaptability, providing possibility of movement on flat roads or rough terrain, or passing through narrow spaces.

Hereinafter, the technical solutions in the embodiments of the present application will be clearly and completely described with reference to the drawings in the embodiments of the present application. It is obvious that the described embodiments are only part of the embodiments of the present application, but not all the embodiments. Based on the embodiments in the present application, all other embodiments obtained by those skilled in the art without creative work fall within the scope of protection of the present application.

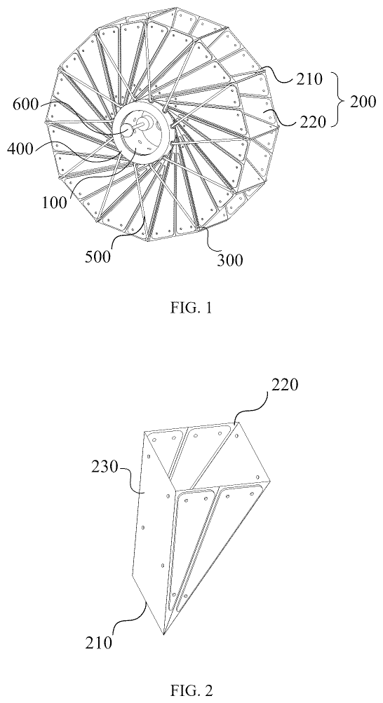

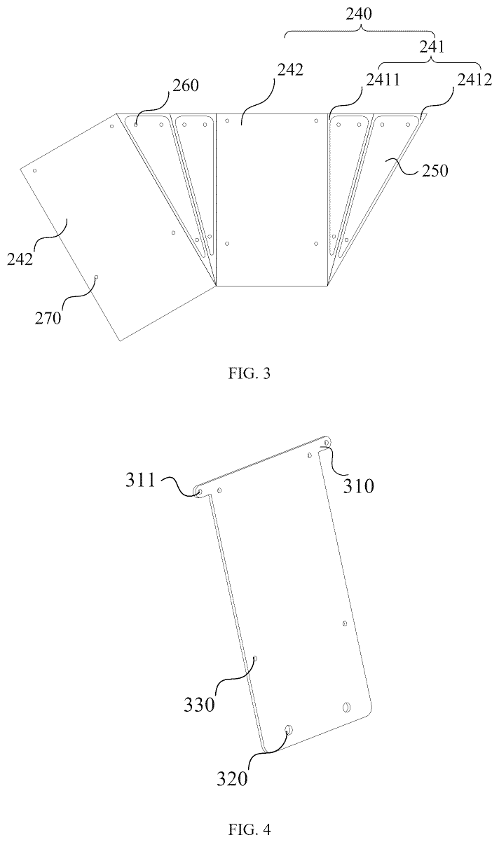

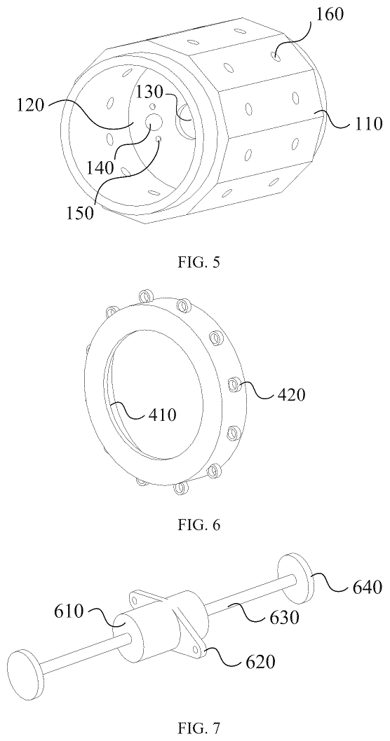

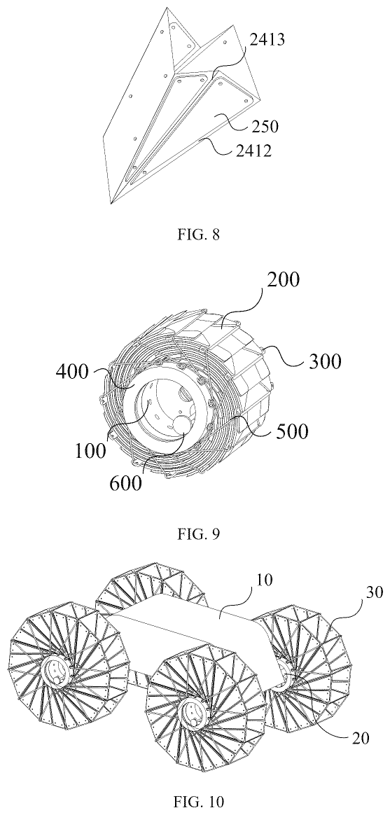

FIG. 1 is a schematic structural diagram of a foldable wheel in an unfolded state according to an embodiment of the present application, FIG. 2 is a schematic structural diagram of a unit cell of a foldable wheel according to an embodiment of the present application, FIG. 3 is a schematic structural diagram of an unfolded unit cell of a foldable wheel according to an embodiment of the present application, FIG. 4 is a schematic structural diagram of a spoke plate of a foldable wheel according to an embodiment of the present application, FIG. 5 is a schematic structural diagram of a hub of a foldable wheel according to an embodiment of the present application, FIG. 6 is a schematic structural diagram of a collar of a foldable wheel according to an embodiment of the present application, FIG. 7 is a schematic structural diagram of a driving system of a foldable wheel according to an embodiment of the present application, FIG. 8 is a schematic structural diagram of a folded unit cell of a foldable wheel according to an embodiment of the present application, FIG. 9 is a schematic structural diagram of a foldable wheel in a folded state according to an embodiment of the present application, and FIG. 10 is a schematic structural diagram of a robot according to an embodiment of the present application.

An embodiment of the present application provides a robot. As shown in FIG. 10, the robot includes an actuator structure 10, a wheel axle 20 (only part of the wheel axle 20 is shown in the figure), and a foldable wheel 30. The actuator structure 10 is located at the upper end of the wheel axle 20, and both ends of the wheel axle 20 are respectively connected to the foldable wheel 30. The robot has a first state and a second state. When the robot is in the first state, the unit cell 200 is in a folded state, and the robot is used to cross a low gap. When the robot is in the second state, the unit cell 200 is in the unfolded state, and the robot is used for fast movement, crossing obstacles, and movement on soft and sinkable road surfaces without slipping.

It should be noted that the number of the wheel axle 20 and the foldable wheel 30 may be set according to actual needs. The actuator structure 10 may be a drive device or an operating structure or a mechanical arm, etc., which will not be described in detail herein.

An embodiment of the present application provides a foldable wheel. As shown in FIG. 1, the foldable wheel includes a hub 100, a plurality of foldable unit cells 200, a plurality of spoke plates 300, a collar 400, an elastic connecting member 500, and a driving structure 600. The spoke plate 300 is disposed between two adjacent unit cells 200, and one end of the spoke plate 300 is connected to the hub 100. Both ends of the hub 100 are each provided with the collar 400 (only the collar 400 at one end is illustrated in the figure), and the collar 400 is rotatablely connected to the hub 100. One end of the elastic connecting member 500 is connected to the spoke plate 300, and the other end of the elastic connecting member 500 is connected to the collar 400. The driving structure 600 is used to drive the collar 400 to rotate in the first direction relative to the hub 100, and the elastic connecting member 500 is used to pull the spoke plate 300 to fit against the hub 100, and drive the unit cell 200 to fold toward the hub 100. The driving structure 600 is also used to drive the collar 400 to rotate relative to the hub 100 in the second direction, release the elastic connecting member 500 that pulls the spoke plate 300 to fit against the hub 100, and use the elastic force of the spoke plate 300 to unfold the unit cell 200.

Where the foldable wheel includes a plurality of foldable unit cells 200, an embodiment of the present application specifically takes twelve sets of unit cells 200 as an example, but is not limited to twelve sets of unit cells 200, such as, it may be having ten sets or thirteen sets, etc. It should be noted that the number of foldable unit cells 200 can be reasonably distributed along the circumferential direction of the hub 100 as required. Each unit cell 200 has a first end 210 and a second end 220, a plurality of unit cells 200 are arranged in a circle along the outer peripheral surface 110 of the hub 100. Each unit cell 200 includes a flexible support layer 240 and a plurality of elastic cover plates 250, and the elastic cover plates 250 are distributed on at least one surface of the flexible support layer 240.

For example, as shown in FIGS. 1 and 2, the unit cell 200 has a first end 210 and a second end 220. The first ends 210 of the plurality of unit cells 200 are arranged in a circle along the outer peripheral surface 110 of the hub 100. When the unit cell 200 is in the folded state, the first end 210 of the unit cell 200 fits against the hub 100, and the second end 220 of the unit cell 200 is away from the hub 100.

Exemplarily, as shown in FIG. 3, each unit cell 200 includes a flexible support layer 240 and a plurality of elastic cover plates 250; the elastic cover plates 250 are distributed on at least one surface of the flexible support layer 240. The embodiment of the present application specifically takes eight elastic cover plates 250 as an example where the eight elastic cover plates 250 are distributed on both surfaces of the flexible support layer 240 to provide a supporting force for the flexible support layer 240. It should be noted that the elastic cover plates 250 may be in any quantity, such as four or six, etc., and the elastic cover plates 250 may be provided on any surface of the flexible support layer 240.

It should be noted that the flexible support layer 240 may be a thermoplastic polymer and has good flexibility. For example, it can be Polyethylene terephthalate (PET) or Polyimide (PI) and the like. The elastic cover plate 250 may be made of titanium alloy or plastic and is flexible.

In some embodiments of the present application, the foldable wheel includes a plurality of spoke plates 300. As shown in FIG. 1, an embodiment of the present application specifically takes twelve spoke plates 300 as an example, but is not limited to twelve spoke plates 300. The spoke plates 300 have elasticity, each spoke plate 300 is located between two adjacent unit cells 200, one end of each spoke plate 300 is connected to the outer peripheral surface 110 of the hub 100 and to the first ends 210 of two adjacent unit cells 200, and the other end of each spoke plate 300 is connected to the second ends 220 of two adjacent unit cells 200. It should be noted that the number of the spoke plate 300 is the same as the number of the unit cell 200. The spoke plate 300 is made of titanium alloy or plastic and is flexible.

In some embodiments of the present application, the flexible support layer 240 includes two opposing folding layers 241 and two connecting layers 242, and at least one surface of each folding layer 241 is provided with an elastic cover plate 250. The two folding layers 241 are connected to the two connecting layers 242, and one ends of the two connecting layers 242 toward the hub 100 are connected, and the two folding layers 241 and the two connecting layers 242 enclose a cavity 230 with an opening at one end, and the opening of the cavity 230 faces away from the hub 100. The connecting layer 242 is connected to both ends of the spoke plate 300.

Exemplarily, as shown in FIGS. 2 and 3, the flexible support layer 240 includes two folding layers 241 and two connecting layers 242. An embodiment of the present application specifically takes an example where both surfaces of each folding layer 241 are each provided with the elastic cover plate 250, the flexible support layer 240 is sandwiched between the two layers of the elastic cover plate 250, and the elastic cover plates 250 are arranged symmetrically along the center of the flexible support layer 240, which strengthens the elasticity and stability of the unit cell 200. The folding layers 241 are disposed opposite each other, and each connecting layer 242 is connected with two folding layers 241 to form a cavity 230. One ends of the two connecting layers 242 toward the hub 100 are connected, that is, the first end 210 of the unit cell 200 is in a closed state. The two folding layers 241 and the two connecting layers 242 enclose an opening at their one ends facing away from the hub 100, that is, the second end 220 of the unit cell 200 is in an open state.

It should be noted that shapes and sizes of the folding layer 241 and the connecting layer 242 may be arbitrary, but both the shapes and the sizes of two oppositely disposed folding layers 241 remain consistent.

In some embodiments of the present application, the folding layer 241 has a first region 2411 and a second region 2412, and at least one surface of the first region 2411 and of the second region 2412 is provided with an elastic cover plate 250. In an embodiment of the present application, both surfaces of the first region 2411 and of the second region 2412 are provided with the elastic cover plate 25 is taken as an example, where when the unit cell 200 is in a folded state, the folding layer 241 is folded toward the inside of the cavity 230, and the first region 2411 and the second region 2412 are at least partially overlapped; and when the unit cell 200 is in the unfolded state, the folding layer 241 is unfolded, and the first region 2411 and the second region 2412 are on the same plane.

Exemplarily, as shown in FIG. 2, each folding layer 241 includes a first region 2411 and a second region 2412, both surfaces of the first region 2411 and of the second region 2412 are provided with an elastic cover plate 250 (only one of the surfaces is shown in the figure), and a pre-formed crease 2413 is provided between the first region 2411 and the second region 2412 to allow the unit cell 200 to be folded along the crease 2413. The elastic cover plate 250 is connected with the folding layer 241 by a rivet hole 260, but the present application is not limited to riveting, for example, it may be bonding or welding, etc.

When the unit cell 200 is in the folded state, for example, as shown in FIGS. 8 and 9, the two folding layers 241 are folded along the crease 2413 toward the inside of the cavity 230, the first region 2411 and the second region 2412 at least partially overlap after folding, and the diameter of the wheel is reduced, the robot can pass through the low gap. When the unit cell 200 is in the unfolded state, such as shown in FIGS. 1 and 2, the two folding layers 241 rebound and support the first region 2411 and the second region 2412 in the same plane with the assistance of the elastic cover plate 250, and the diameter of the wheel increases so that the robot can cross a large step or an undulating road surface. It should be noted that the crease 2413 of the folding layer 241 is located between the first region 2411 and the second region 2412, and the crease 2413 is configured to fold the folding layer 241 toward the cavity 230 of the unit cell 200.

In some embodiments of the present application, as shown in FIG. 3, the first region 2411 and the second region 2412 of the folding layer 241 gradually increase in the direction from the first end 210 to the second end 220 of the unit cell 200. That is, the first region 2411 and the second region 2412 of the folding layer 241 gradually increase along a linear direction from the first end 210 to the second end 220 of the unit cell 200, which is, on one hand, to better connect the folding layer 241 and the connecting layer 242, and on the other hand, to make the unit cell 200 have greater flexibility in the folded state or the unfolded state.

It should be noted that the shapes and sizes of the first region 2411 and the second region 2412 may be the same or different. In the embodiment of the present application, the first region 2411 is a right-angled triangle and the second region 2412 is an obtuse-angled triangle, but the present application is not limited to the above two shapes, and may be, for example, an acute-angled triangle or the like.

In some embodiments of the present application, two protrusions 310 are provided on one end of the spoke plate 300 facing away from the hub 100, and one end of the elastic connecting member 500 is connected to the spoke plate 300 through the protrusion 310. Exemplarily, as shown in FIGS. 1 and 4, two protrusions 310 are provided on one end of the spoke plate 300 (in the direction facing away from the hub 100), each protrusion 310 is provided with a sixth connecting hole 311, and the other end of the spoke plate 300 (in the direction facing the hub 100) is provided with two fifth connecting holes 320, and the spoke plate 300 is further provided with a plurality of second openings 330. It should be noted that, in the embodiment of the present application, each spoke plate 300 is provided with four second connecting holes 140, but the second connecting hole is not limited to four in quantity, and may be in any quantity, such as five or six.

It can be understood that the elastic connecting member 500 is connected to one end of the spoke plate 300 through the sixth connecting hole 311 on the protrusion 310. Combined with FIGS. 4 and 5, the fifth connecting hole 320 at the other end of the spoke plate 300 and the fourth connecting hole 160 on the hub 100 are connected by a bolt, and part of the spoke plate 300 is fixed on the hub 100. In an embodiment of the present application, twelve spoke plates 300 are arranged along the outer peripheral surface 110 of the hub 100. As shown in FIGS. 3 and 4, each connecting layer 242 of the unit cell 200 is provided with four first openings 270, the second opening 330 of the spoke plate 300 is connected with the first openings 270 of two adjacent unit cells 200 by a bolt, and the spoke plate 300 is sandwiched and fixed between the two adjacent unit cells 200.

It should be noted that the number, shape, and size of the protrusion 310 on the spoke plate 300 may be set according to actual needs, and are not limited to the shape of the present embodiment, and may be, for example, rectangular.

In some embodiments of the present application, a partition plate 120 is provided in the hub 100, the partition plate 120 is provided with a first connecting hole 130 and a second connecting hole 140, and the first connecting hole 130 is located at a center position of the partition plate 120.

Exemplarily, as shown in FIG. 5, the hub 100 has an outer peripheral surface 110, the outer side of the hub 100 is a polygon, and the number of sides of the polygon is the same as the number of the unit cell 200. In an embodiment of the present application, the number of the unit cell 200 is twelve sets, and the number of sides of the polygon on the outer side of the hub 100 is also twelve. The inner side of the hub 100 is a cylindrical structure, and the cylindrical structure on the inner side of the hub 100 extends beyond the polygonal outer peripheral surface 110 on the outer side of the hub 100, so that the collar 400 may be sleeved on the hub 100 to realize rotatable connection.

It should be noted that a bearing (not shown in the figure) is further provided between the hub 100 and the collar 400, and the bearing is used to make the rotation between the hub 100 and the collar 400 smoother, reducing friction and ensuring better fitting.

Continuing to refer to FIG. 5, and combined with FIG. 1, the inside of the hub 100 is provided with a partition plate 120, and the center position of the partition plate is provided with a first connecting hole 130. The first connecting hole 130 is configured to fix the wheel axle 20 (not shown in the figure) to allow the wheel to rotate along the wheel axle 20. The partition plate is also provided with a second connecting hole 140, and the driving structure 600 is provided in the second connecting hole 140 to be connected with the hub 100. A third connecting hole 150 is also provided around the second connecting hole 140, and the third connecting hole 150 is configured to fix the driving structure 600 to the hub 100.

In some embodiments of the present application, the driving structure 600 includes a motor 610, both ends of the motor 610 are each provided with a connecting shaft 630, and the other end of each connecting shaft 630 is provided with a gear head 640. When the motor 610 operates to drive the gear head 640 to rotate in a first direction, the unit cell 200 is in a folded state, and when the motor 610 operates to drive the gear head 640 to rotate in a second direction, the unit cell 200 is in an unfolded state. The second direction is opposite to the first direction. An internal gear 410 is provided in the collar 400, and the internal gear 410 is meshed with a gear head 640 of the motor 610.

Exemplarily, as shown in FIG. 6, an internal gear 410 (gear is not shown) is provided within the collar 400. As shown in FIG. 7, the driving structure 600 includes a motor 610, both ends of which are each provided with a connecting shaft 630, one end of connecting shaft 630 is connected to the motor 610, and the other end of the connecting shaft 630 is provided with a gear head 640 (gear is not shown). The motor 610 operates to drive the gear head 640 to rotate in a first direction or a second direction, and the gear head 640 of the motor 610 meshes with the internal gear 410 of the collar 400.

As shown in FIG. 1, when the gear head 640 rotates in the first direction, the collar 400 rotates in the first direction relative to the hub 100, the elastic connecting member 500 connected to the collar 400 pulls the spoke plate 300, and the folding layer 241 of the foldable unit cell 200 is folded toward the interior of the cavity 230 along the crease 2413, and the unit cell 200 is in a folded state. When the gear head 640 rotates in the second direction, the collar 400 rotates in the second direction relative to the hub 100, the elastic connecting member 500 connected to the collar 400 releases the force that pulls the spoke plate 300, and the folding layer 241 of the foldable unit cell 200 is unfolded under rebound action of the spoke plate 300 so that the first region 2411 and the second region 2412 of the folding layer 241 are located on the same plane, and the unit cell 200 is in an unfolded state.

In some embodiments of the present application, the motor 610 is provide in the second connecting hole 140 of the partition plate 120. The motor 610 is further provided with at least one connecting portion 620, and the motor 610 is connected to the partition plate 120 of the hub 100 through the connecting portion 620. Exemplarily, as shown in FIGS. 1, 5 and 7, in an embodiment of the present application, two connecting portions 620 are provided on the motor 610, the motor 610 goes through the second connecting hole 140 of the hub 100 so as to fix the two connecting portions 620 to the third connecting hole 150 on the partition plate 120 of the hub 100 by a bolt, so that the motor 610 drives the gear head 640 to rotate relative to the hub 100 through the connecting shaft 630.

In some embodiments of the present application, a plurality of pull rings 420 are further provided outside the collar 400, and the other end of the elastic connecting member 500 is connected to the collar 400 through the pull ring 420. Exemplarily, as shown in FIGS. 1 and 6, in an example of the present application, the number of the pull ring 420 is twelve, but the number of the pull ring 420 is not limited to twelve, and may be any number, such as ten or thirteen. And the pull rings 420 are arranged at equal intervals along the outer peripheral surface of the collar 400. It should be noted that the number of the pull ring 420 on the collar 400 is the same as the number of the foldable unit cell 200.

Herein, terms such as “upper” and “lower” are used to describe the relative positional relationship of individual structures in the drawings, and are only for the purpose of clarity of the description, and are not intended to limit the scope of implementation of the present application. Changes or adjustments of the relative relationship, without substantial changes in the technical contents, are also regarded as the scope of implementation of the present application.

It should be noted that in the present application, unless expressly specified and defined, the first feature being “above” or “below” the second feature may refer to a direct contact between the first and second features, or an indirect contact between the first and second features through an intermediate medium. Furthermore, the first feature being “above”, “over” and “on” the second feature may mean that the first feature is directly above or obliquely above the second feature or simply mean that the first feature is horizontally higher than the second feature. The first feature is “under”, “below” and “beneath” the second feature may mean that the first feature is directly below or obliquely below the second feature, or simply mean that the first feature is horizontally lower than the second feature.

Furthermore, in the present application, unless otherwise expressly provided and limited, the terms “install”, “connect to”, “connect with”, “fix”, etc. shall be broadly understood; e.g., it may be a fixed connection, a detachable connection, or forming one piece; it may be a direct connection or an indirect connection through an intermediate medium; it may be a communication within two elements or the interaction between two elements. Those skilled in the art can understand the specific meanings of the above-mentioned terms in the present application according to the concrete conditions.

In the description of the present specification, description with reference to the terms “one embodiment”, “some embodiments”, “exemplary embodiments”, “example”, “specific example”, or “some examples”, etc. means that a specific feature, structure, material, or characteristics described in combination with the embodiment or example is included in at least one embodiment or example of the present disclosure. In the present specification, exemplary expressions of the above terms do not necessarily refer to the same embodiments or examples. Moreover, the described specific features, structures, materials, or characteristics may be combined in any one or more embodiments or examples in a suitable manner.

Finally, it should be noted that the foregoing embodiments are merely intended for describing the technical solutions of the present application other than limiting the present application. Although the present application is described in detail with reference to the foregoing embodiments, persons of ordinary skill in the art should understand that they may still make modifications to the technical solutions described in the foregoing embodiments or make equivalent substitutions to some technical features therein. However, these modifications or substitutions do not cause the essence of the corresponding technical solutions out of the scope of the technical solutions of the embodiments of the present application.

What is claimed is:

1. A foldable wheel, comprising:
a hub with an outer peripheral surface;
a plurality of foldable unit cells, wherein each unit cell has a first end and a second end, the plurality of unit cells are arranged in a circle along the outer peripheral surface of the hub, and each unit cell comprises a flexible support layer and a plurality of elastic cover plates distributed on at least one surface of the flexible support layer;
a plurality of spoke plates with elasticity, where each spoke plate is positioned between two adjacent unit cells, one end of each spoke plate is connected to the outer peripheral surface of the hub and connected to first ends of the two adjacent unit cells, and the other end of each spoke plate is connected to second ends of the two adjacent unit cells;
a collar, arranged at each of both ends of the hub, the collar being rotatably connected with the hub;
an elastic connecting member, one end of which is connected to the spoke plate and the other end of which is connected to the collar; and
a driving structure, driving the collar to rotate so that the elastic connecting member drives the unit cell to fold or unfold.

2. The foldable wheel according to claim 1, wherein the flexible support layer comprises two opposite folding layers and two connecting layers;
at least one surface of each folding layer is provided with the elastic cover plate;
the two folding layers are connected with the two connecting layers, and ends of the two connecting layers towards the hub are connected, the two folding layers and the two connecting layers enclose a cavity with an opening at one end, and the opening of the cavity faces away from the hub; and
the connecting layer is connected with both ends of the spoke plate.

3. The foldable wheel according to claim 2, wherein the folding layer has a first region and a second region, at least one surface of each of the first region and the second region is provided with the elastic cover plate;
when the unit cell is in a folded state, the folding layer is folded toward the cavity, and the first region and the second region are at least partially overlapped; and
when the unit cell is in the unfolded state, the folding layer is unfolded, and the first region and the second region are in a same plane.

4. The foldable wheel according to claim 3, wherein the first region and the second region gradually increase in a direction from the first end to the second end of the unit cell.

5. The foldable wheel according to claim 1, wherein two protrusions are provided on an end of the spoke plate facing away from the hub, and one end of the elastic connecting member is connected to the spoke plate by the protrusion.

6. The foldable wheel according to claim 5, wherein the flexible support layer comprises two opposite folding layers and two connecting layers;
at least one surface of each folding layer is provided with the elastic cover plate;
the two folding layers are connected with the two connecting layers, and ends of the two connecting layers towards the hub are connected, the two folding layers and the two connecting layers enclose a cavity with an opening at one end, and the opening of the cavity faces away from the hub; and
the connecting layer is connected with both ends of the spoke plate.

7. The foldable wheel according to claim 6, wherein the folding layer has a first region and a second region, at least one surface of each of the first region and the second region is provided with the elastic cover plate;
when the unit cell is in a folded state, the folding layer is folded toward the cavity, and the first region and the second region are at least partially overlapped; and
when the unit cell is in the unfolded state, the folding layer is unfolded, and the first region and the second region are in a same plane.

8. The foldable wheel according to claim 7, wherein the first region and the second region gradually increase in a direction from the first end to the second end of the unit cell.

9. The foldable wheel according to claim 5, wherein the hub is internally provided with a partition plate, the partition plate is provided with a first connecting hole and a second connecting hole, and the first connecting hole is located at a central position of the partition plate.

10. The foldable wheel according to claim 9, wherein the driving structure comprises a motor, both ends of the motor are each provided with a connecting shaft, and the other end of each connecting shaft is provided with a gear head;
when the motor runs and drives the gear head to rotate in a first direction, the unit cell is in a folded state, and when the motor runs and drives the gear head to rotate in a second direction, the unit cell is in an unfolded state;
the second direction is opposite to the first direction; and
an internal gear is provided in the collar, and the internal gear is meshed with the gear head of the motor.

11. The foldable wheel according to claim 10, wherein the motor is provided in the second connecting hole of the partition plate; and
the motor is also provided with at least one connecting portion, and the motor is connected with the partition plate of the hub through the connecting portion.

12. The foldable wheel according to claim 11, wherein a plurality of pull rings are further provided outside the collar, and the other end of the elastic connecting member is connected to the collar by the pull ring.

13. A robot, comprising:
an actuator structure, a wheel axle, and the foldable wheel according to claim 1, wherein the actuator structure is located at an upper end of the wheel axle, both ends of the wheel axle are each connected to a first connecting hole of the hub of the foldable wheel;
the robot has a first state and a second state, and when the robot is in the first state, the unit cell is in a folded state, and the robot is used to cross a low gap; and
when the robot is in the second state, the unit cell is in an unfolded state, and the robot is used to quickly move or cross a road obstacle.

14. The robot according to claim 13, wherein the flexible support layer comprises two opposite folding layers and two connecting layers;
at least one surface of each folding layer is provided with the elastic cover plate;
the two folding layers are connected with the two connecting layers, and ends of the two connecting layers towards the hub are connected, the two folding layers and the two connecting layers enclose a cavity with an opening at one end, and the opening of the cavity faces away from the hub; and
the connecting layer is connected with both ends of the spoke plate.

15. The robot according to claim 14, wherein the folding layer has a first region and a second region, at least one surface of each of the first region and the second region is provided with the elastic cover plate;
when the unit cell is in a folded state, the folding layer is folded toward the cavity, and the first region and the second region are at least partially overlapped; and
when the unit cell is in the unfolded state, the folding layer is unfolded, and the first region and the second region are in a same plane.

16. The robot according to claim 15, wherein the first region and the second region gradually increase in a direction from the first end to the second end of the unit cell.

17. The robot according to claim 13, wherein two protrusions are provided on an end of the spoke plate facing away from the hub, and one end of the elastic connecting member is connected to the spoke plate by the protrusion.

18. The robot according to claim 17, wherein the hub is internally provided with a partition plate, the partition plate is provided with a first connecting hole and a second connecting hole, and the first connecting hole is located at a central position of the partition plate.

19. The robot according to claim 18, wherein the driving structure comprises a motor, both ends of the motor are each provided with a connecting shaft, and the other end of each connecting shaft is provided with a gear head;
when the motor runs and drives the gear head to rotate in a first direction, the unit cell is in a folded state, and when the motor runs and drives the gear head to rotate in a second direction, the unit cell is in an unfolded state;
the second direction is opposite to the first direction; and
an internal gear is provided in the collar, and the internal gear is meshed with the gear head of the motor.

20. The robot according to claim 19, wherein the motor is provided in the second connecting hole of the partition plate; and
the motor is also provided with at least one connecting portion, and the motor is connected with the partition plate of the hub through the connecting portion.
